(19) United States
(12) Patent Application Publication
(10) Pub. No.: US 2025/0132486 A1
(43) Pub. Date: Apr. 24, 2025

(54) Antenna arrangement for receiving and transmitting electromagnetic waves of different polarization

(71) Applicant: SICK AG, Waldkirch (DE)

(72) Inventor: Florian PUDENZ, Hamburg (DE)

(21) Appl. No.: 18/904,524

(22) Filed: Oct. 2, 2024

(30) Foreign Application Priority Data
Oct. 18, 2023 (EP) 23204364.6

(51) Int. Cl. H01Q 1/22; H01Q 9/04; H01Q 21/24

(52) U.S. Cl. CPC H01Q 1/2208; H01Q 9/0428; H01Q 21/24

(57) ABSTRACT

An antenna arrangement for receiving and transmitting electromagnetic waves of different polarization includes an antenna that has at least two feed points arranged spaced apart. The antenna arrangement includes a signal input for a high-frequency input signal and a coupler circuit coupled to the signal input. The coupler circuit includes a first coupler input connected to a first node; a second coupler input connected to a second node; a first coupler output connected to a third node; and a second coupler output connected to a fourth node. The first and third node are electrically coupled to one another via a first line, the second and fourth node are electrically coupled to one another via a third line, a first switching apparatus can electrically couple the first and second node via a second line and a second switching apparatus can electrically couple the third and fourth node via a fourth line.

The invention relates to an antenna arrangement for receiving and transmitting electromagnetic waves of different polarization as well as to a corresponding method and a coupler circuit.

Such antenna arrangements can comprise a feed network. A feed network serves to couple signals of a transmission-reception unit into an antenna structure at more than one feed point with as low losses as possible. The feed network ensures, e.g. by means of a coupler circuit, that predefined portions of the input signal are present at the outputs of the network at a desired phase angle to obtain a desired polarization of the transmitted signal. The lower the losses in the network (for signal division and forwarding), the higher the amplitude of the output signal(s) fed to the antenna. This effect is in particular pronounced with RFID antennas since the same antenna (of the RFID reader) is used for transmission and reception operation.

Depending on the application, different polarizations can be advantageous. If the orientation of a transponder is not known, the use of a circularly polarized antenna, i.e. of an antenna that receives and transmits circularly polarized electromagnetic waves, offers significant advantages since the variance in the orientation of the transponder can be better compensated so that information can be read better. However, since the transponders only have a linearly polarized antenna in most cases, the transponder can (ideally) only absorb half of the received energy of the electromagnetic wave. In applications in which the transponders have a predefined, known alignment to the reader, it would thus be advantageous to use an antenna with a linear polarization in the reader so that, with a correct alignment (of the reader in relation to the transponder), the transponder can absorb more energy so that a greater identification range is achieved.

Consequently, there is a need for an antenna arrangement that can generate signals of different polarization.

It is an underlying object of the invention to provide an antenna arrangement and a method for receiving and transmitting electromagnetic waves of different polarization as well as a coupler circuit.

This object is satisfied by the subjects of the independent claims.

The invention relates to an antenna arrangement, in particular an RFID antenna arrangement, for receiving and transmitting electromagnetic waves of different polarization, said antenna arrangement comprising:
an antenna that has at least two feed points arranged spaced apart from one another, wherein the antenna is configured to transmit a polarized electromagnetic wave;
a signal input for a high-frequency input signal and/or having a high-frequency input signal;
a coupler circuit that is coupled to the signal input and that comprises:
a first coupler input connected to a first node;
a second coupler input connected to a second node;
a first coupler output connected to a third node; and
a second coupler output connected to a fourth node,
wherein the first and third node are electrically coupled to one another via a first line,
wherein the second and fourth node are electrically coupled to one another via a third line,
wherein the first and second node can be electrically coupled via a second line by means of a first switching apparatus,
wherein the third and fourth node can be electrically coupled via a fourth line by means of a second switching apparatus,
wherein the signal input can be coupled to the first coupler input or to the second coupler input, wherein the first and second coupler output are each connected to one or more feed points of the antenna.

In other words, the first and third node and the second and fourth node are permanently and preferably directly electrically coupled to one another by means of the first or third line. The electrical connection between the first and second node and between the third and fourth node can be selectively established via the first switching apparatus or the second switching apparatus. For example, the first switching apparatus can be switched such that an electrical connection can be established between the first and the second node via the second line (and in particular the first switching apparatus). This state is described below as the coupling state of the switching apparatus. However, the first switching apparatus can also be operated such that there is no electrical connection between the first and second node, which is referred to below as the decoupling state. This applies accordingly to the second switching apparatus and the third and fourth nodes.

The signal input can preferably always be coupled only either to the first coupler input or only to the second coupler input.

According to a first embodiment, the coupler circuit can be operated in a decoupling mode and in a coupling mode, wherein the coupler circuit is configured in the decoupling mode such that the first and second switching apparatus are operated in a decoupling state so that the signal input is only connected to the first or second coupler output. In this respect, the antenna is preferably configured in the decoupling mode to transmit a linearly polarized electromagnetic wave. Furthermore, the coupler circuit can be configured in a coupling mode such that the first and/or second switching apparatus is/are operated in a coupling state so that the signal input is connected to the first and second coupler output, wherein the antenna is preferably configured in the coupling mode to transmit a circularly polarized or elliptically polarized electromagnetic wave.

In the decoupling mode, for example, the first node is therefore only electrically coupled to one further node, namely the third node. Accordingly, the second node can only be electrically coupled to the fourth node. The input signal present at either the first or second coupler input is then only forwarded to one coupler output, namely either the first or the second coupler output. Accordingly, the antenna receives the input signal only at one feed point, whereby a linearly polarized electromagnetic wave is preferably generated by the antenna.

In the coupling mode, on the other hand, an input signal at a coupler input can be divided between both coupler outputs. As an example, an input signal is for this purpose assumed at the first coupler input and thus at the first node. Furthermore, it is assumed by way of example here that the first to fourth lines each generate a phase offset of 90°.

In the coupling mode, the input signal can travel from the first node to the third node via the first line and can experience a phase offset of 90° in the process. At the same time, the input signal can reach the fourth node via the second and third lines and in this respect experiences a phase offset of 90° twice, i.e. of 180° in total. Accordingly, the input signal is divided between two feed points of the antenna, wherein the signals at the two feed points have a phase offset of 90° from one another and it is made possible in this way to transmit e.g. a circularly polarized wave.

The antenna arrangement is thus able to set different operating modes by means of the first and second switching apparatus, in which operating modes different output signals are provided at the coupler outputs in that the forwarding of the input signal, for example a high-frequency signal, is defined based on the state of the switching apparatus. In particular, depending on the operating state of the first and second switching apparatus, it is defined at which coupler outputs an output signal is provided. Furthermore, depending on the operating state of the switching apparatus, the phase and/or amplitude of the output signals of the coupler outputs can be set, in particular in relation to the input signal, wherein the state of the switching apparatus defines whether the input signal is divided or not. The operating state of the respective switching apparatus can, for example, be controlled by controlling the antenna arrangement. When a “phase offset” is spoken of below, a phase offset in relation to the input signal is in particular described hereby, unless otherwise specified.

The phase offset of the output signals output at the first and second coupler output in relation to the phase of the input signal in particular depends on the electrical length of the lines. The “electrical length” of an electrical line refers to the length of the line through which the signal is transmitted. Electrical signals that propagate through lines are subject to various phase offsets, delays and deformations. The phase offset in particular depends on the electrical length of the line. In the following, the term electrical length can also be used synonymously with a phase offset caused by an electrical line or an electrical component.

Furthermore, the amplitude of the output signals output at the first and second coupler output in particular depends on the impedance of the lines and on the amplitude of the input signal.

Using the above properties, the high-frequency signal present at the signal input can be forwarded and adapted by means of the coupler circuit such that different output signals are provided at the coupler outputs.

In the following, it is assumed that the signal input is connected to the first coupler input. However, a corresponding mode of operation of the coupler circuit can also be achieved if the signal input is connected to the second coupler output, wherein the output signals at the coupler outputs described below would then be swapped. In particular, depending on the coupler input at which the input signal is present, a polarization direction, i.e. left-circulating or right-circulating, and/or a polarization angle, for example of a linearly polarized electromagnetic wave, can be defined.

If the switching apparatus is operated in the coupling mode, i.e. if the first and/or second switching apparatus is/are in the coupling state, i.e. in a state in which there is an electrical connection between the first and second node and/or the third and fourth node, for example by closing a switch of a respective switching apparatus, the processing of the radio frequency signal present at the signal input can take place as follows:

The input signal can be conducted via the first coupler input and via the first line to the first coupler output so that an output signal is present at the first coupler output and corresponds to a converted, in particular phase-shifted and amplitude-altered, input signal. The output signal of the first coupler output thus in particular has a phase offset corresponding to the electrical length of the first line and a respective amplitude.

Furthermore, the input signal can be conducted via two possible paths to the second coupler output, wherein the input signal can be conducted via both paths to the second coupler output when both the first and the second switching apparatus are operated in the coupling state. Alternatively, the input signal can only be conducted via one of the two paths to the second coupler output if one of the two switching apparatus is operated in the decoupling state and the other of the two switching apparatus is operated in the coupling state. The case when the input signal is conducted via both paths to the second coupler output is described below.

The input signal can, for example, be conducted via a first path from the first node via the second line to the second node and from the second node via the third line to the fourth node. Furthermore, the input signal can be conducted via a second path from the first node via the first line to the third node and from the third node via the fourth line to the fourth node. In particular, the input signal conducted via the first path and the input signal conducted via the second path are thus combined at the fourth node so that the output signal output at the second coupler output corresponds to an addition of the signals transmitted via the first path and via the second path. In particular, the electrical length of the first path, i.e. the common electrical length of the second line including the electrical length of the first switching apparatus and the third line, is in this respect at least substantially equal to the electrical length of the second path, i.e. the common electrical length of the first line and the fourth line including the electrical length of the second switching apparatus. In particular, the phase offset of the signals transmitted via the first path and via the second path is thus the same. Furthermore, the cumulative impedances of the first path and the second path, i.e. the common impedance of the second line and the third line and the common impedance of the first line and the fourth line, can also at least substantially be of equal magnitude.

In particular, the phase offset of the combined output signal of the second coupler output corresponds to the phase offset of the signals transmitted via the first path and the second path. The amplitude of the output signal of the second coupler output is in particular determined by the impedances of the respective lines. The output signal of the second coupler output, for example, has a phase offset corresponding to the electrical length of the first path and/or the second path and a respective amplitude.

The output signal of the first coupler output and the output signal of the second coupler output can thus have a different phase offset and, depending on the impedance of the lines, also a different amplitude. Accordingly, the output signal of the first coupler output and the output signal of the second coupler output can be fed into the antenna, for example a patch antenna, via the feed points of the antenna in order to generate and transmit a circularly polarized or elliptically polarized electromagnetic wave. To generate a circularly polarized or elliptically polarized polarization, two supply lines of the feed points are, for example, attached to the antenna offset from one another, in particular by 90°. An offset of the feed points by 90° can, for example, be provided in a patch antenna, wherein the angle is e.g. measured from a center point or center of gravity of the antenna. The arrangement of the feed points can, for example, be selected depending on the phase position of the output signals and the output impedance (matching) of the coupler circuit. In particular, the position of the feed point in a patch antenna, e.g. between the patch center (approx. 0 Ohm) and the patch edge (approx. 200 Ohm), is selected so that the impedance is matched to the impedance of the coupler circuit.

As already indicated above, with a symmetrical patch design (e.g. circle, square, octagon and the like), the geometric angle of the arrangement of the feed point in the patch antenna can also correspond to the phase angle of the feed signals. For example, two input signals with a 90° phase offset are preferably inserted into two feed points arranged orthogonally to one another. Other orientations are conceivable for asymmetrical patch contours, e.g. a rectangle, triangle, oval and the like.

In the coupling state, the coupler circuit can thus be operated as a branchline coupler.

If the switching apparatus is operated in the decoupling mode, i.e. when the two switching apparatus are in the decoupling state, i.e. in a state in which an electrical connection between the first and second node or the third and fourth node is interrupted, for example by a switch of a respective switching apparatus being open, the feeding in of the high-frequency signal present at the signal input can take place as follows:

The input signal can be conducted via the first coupler input and via the first line to the first coupler output so that an output signal is present at the first coupler output and corresponds to a converted, in particular phase-shifted and amplitude-altered, input signal. The output signal of the first coupler output thus in particular has a phase offset corresponding to the electrical length of the first line and a respective amplitude. Due to the decoupling state of the switching apparatus, the input signal cannot be conducted to the second coupler output so that the second coupler output is isolated. In particular, the input signal is substantially conducted completely to the first coupler output. The output signal of the first coupler output can be fed into the antenna via a feed point of the antenna and results in a linearly polarized electromagnetic wave being generated and transmitted. For example, a supply line of the feed point or the feed points is positioned in a straight line or at a certain angle to the alignment of the antenna. The resulting radiation can be linearly polarized, for example horizontally, vertically or at any desired other angle, depending on the orientation of the supply line.

In both operating modes of the coupler circuit, the second coupler input can be short-circuited to ground, in particular via a terminating resistor, to achieve a termination that is as good as possible, in particular a total reflection of the transmission signal.

The antenna arrangement according to the invention thus makes it possible to switch between a mode of a linear polarization, i.e. a decoupling mode, and a mode of a circular or elliptical polarization, i.e. a coupling mode. The polarization can hereby be flexibly switched depending on the respective application. If a undefined number of transponders are to be identified, for example, by means of an antenna arrangement, such as an RFID reader, the RFID reader can identify a first number of RFID transponders in a first “coarse” readout process using circularly polarized RF waves and can identify further RFID transponders, which could not be identified in the first readout process due to the lower transmission power, in a second “fine” readout process using linearly polarized RF waves that have a higher transmission power than the circularly polarized RF waves.

A further advantage of the invention is in particular that a standard branchline coupler can be adapted with a few additional components such that both a linear polarization and a circular or elliptical polarization can be generated. The invention can thus in particular be realized with little expenditure and in a space-saving manner.

The antenna can in particular comprise a double bifilar helical antenna, a patch antenna, a cross-fed antenna or a quadrature antenna. The electromagnetic waves transmitted by the antenna can further comprise microwaves, infrared waves, RF waves and/or laser beams or the like. The high-frequency input signal can further have a wavelength that is less than 500 cm, less than 100 cm or less than 50 cm, in particular 32 cm. The high-frequency input signal can preferably have a frequency in an ISM band (Industrial, Scientific and Medical Band), in particular in the frequency range between 902 and 928 MHz.

According to a further embodiment, an electrical length of the first line substantially corresponds to an electrical length of the third line, wherein the electrical length of the first and/or third line corresponds to an electrical length L1 in each case, wherein an electrical length of the second line substantially corresponds to an electrical length of the fourth line, wherein the electrical length of the second and fourth line corresponds to an electrical length L2 in each case, wherein an electrical length of the first switching apparatus substantially corresponds to an electrical length of the second switching apparatus, wherein the electrical length of the first and second switching apparatus corresponds to an electrical length L_{S} in each case, wherein a phase offset L_{2S} caused jointly by the electrical lengths L2 and L_{S} at least substantially corresponds to an odd integer multiple of 90°. The same can also apply to L1, i.e. that L1 causes a phase offset that at least substantially corresponds to an odd integer multiple of 90°.

In the coupling mode, it can thus be ensured that the output signal of the first coupler output is phase-shifted by an electrical length L1, while the output signal of the second coupler output is phase-shifted by an electrical length L_{12S}=L1+L_{2S}. In particular, the phase offset between the output signal of the first coupler output and the output signal of the second coupler output corresponds to the electrical length L_{2S} that corresponds to an odd integer multiple of 90°, in particular 90°. Thus, the signals fed in at the two feed points of the antenna also have a phase offset of 90° in relation to one another so that a circularly polarized or at least elliptically polarized electromagnetic wave is transmitted. It is generally also possible that the second and fourth line and the first and second switching apparatus are configured such that the phase offset L_{2S} assumes a value that does not correspond to an odd integer multiple of 90°. In such a case, an elliptically polarized electromagnetic wave results. The electrical lengths L2 and L_{S} are in particular matched to one another such that the phase offset L_{2S} does not assume a value that corresponds to an even integer multiple of 180° since a linearly polarized electromagnetic wave would be generated in this case.

According to a further embodiment, the first and third line each have a first impedance Z₁ that is in particular substantially of the same magnitude, wherein the second and fourth line each have a second impedance Z₂ that is in particular substantially of the same magnitude, wherein the first impedance Z₁ and the second impedance Z₂ are selected such that output signals with substantially the same amplitude are output at the first coupler output and the second coupler output.

The impedances Z₁ and Z₂ are in particular matched to one another. When matching the impedances, an impedance Z_{S} of the switching apparatus can further be considered, with the first and second switching apparatus preferably having an impedance of substantially the same magnitude. When matching the impedances, it is, for example, also considered that the output signal of the second coupler output is generated in the coupling mode based on a combination of the input signal conducted via the first path and via the second path. Z₂ can, for example, amount to 50 ohms so that Z₁ assumes a rounded value of 35.35 ohms. The coupler circuit can, for example, be configured such that the power of the input signal is divided into two parts of equal amplitude, i.e. output signals that each have 3 dB less power compared to the input signal.

According to a further embodiment, the coupler circuit can be operated in a partial coupling mode in which the first switching apparatus is operated in the coupling state and the second switching apparatus is operated in the decoupling state or vice versa, wherein the antenna is configured to transmit an elliptically polarized electromagnetic wave in the partial coupling mode.

In the partial coupling mode, the input signal can thus only be conducted to the second coupler output via the first path or the second path. Consequently, this also affects the amplitude of the output signal of the second coupler output. In particular, the amplitude of the output signal of the first coupler output is not equal to the amplitude of the output signal of the second coupler output. Furthermore, the phase offset between the output signal of the first coupler output and the output signal of the second coupler output in the partial coupling mode can also be unequal to an odd integer multiple of 90°. The electromagnetic wave generated by the antenna can hereby have an elliptical polarization. More precisely, to generate an elliptical polarization, only one of the two switches is preferably operated in the coupling mode, whereby signals with a phase offset of a 90° difference are present at the outputs of the coupler circuit. However, different amplitudes can result due to the impedance differences of L1 and L2. For example, for a symmetrical patch structure, the feeding in at two orthogonal feed points with a 90° phase offset and an unequal amplitude means that an elliptical polarization is generated. By using the coupler circuit in the partial coupling mode, an additional, i.e. elliptical, polarization can thus be generated that may be desired in some applications if, for example, only a predefined range is to be scanned with a higher transmission power.

According to a further embodiment, the first switching apparatus is arranged at an end of the second line that is closer to the first line, in particular in close proximity to the first node, and the second switching apparatus is arranged at an end of the fourth line that is closer to the third line, in particular in close proximity to the fourth node, or the first switching apparatus is arranged at an end of the second line that is closer to the third line, in particular in close proximity to the second node, and the second switching apparatus is arranged at an end of the fourth line that is closer to the first line, in particular in close proximity to the third node.

According to a further embodiment, the first switching apparatus is arranged between a first subline of the second line and a second subline of the second line and/or the second switching apparatus is arranged between a first subline of the fourth line and a second subline of the fourth line.

The first subline of the second line and the second subline of the second line are in particular configured such that a phase offset caused jointly by an electrical length L21 of the first subline of the second line, by an electrical length L22 of the second subline of the second line and by the switching apparatus substantially corresponds to an odd integer multiple of 90°. In particular, this also applies to the electrical length L41 of the first subline of the fourth line and to an electrical length L42 of the second subline of the fourth line. The impedances of the first and second sublines for the second line and/or for the fourth line are in particular of equal magnitude.

According to a further embodiment, the first and/or second switching apparatus is/are configured in the decoupling state to connect the first or second subline to a ground line, i.e. to a line element short-circuited to ground. In particular, the ground line has an impedance Z_{M} and is short-circuited to ground at one end. In the decoupling mode, this additional line element can optimize the transmission attenuation, i.e. the isolation of the second coupler output, since mismatches of the coupler circuit, in particular of the impedances, of the electrical lengths of the lines and of the switching apparatus, can be partly compensated.

According to a further embodiment, the first and/or second switching apparatus is/are configured in the decoupling state to connect the first or second subline to an additional line with an open end. I.e. instead of a non-contacted open port R at the first and/or second switching apparatus, the first or second subline is connected to the additional line that has an open end and an impedance Z₃. In this embodiment, the additional line element can also optimize the transmission attenuation, i.e. the isolation of the second coupler output, in the decoupling mode since mismatches of the coupler circuit, in particular of the impedances, of the electrical lengths of the lines and of the switching apparatus, can be partly compensated.

In particular, the choice of the additional line element, i.e. whether the ground line or the additional line is used, can take place in dependence on the kind of switching apparatus, in particular in dependence on the phase response or phase offset of the passed-through signal generated by the switching apparatus. The ground line and/or the additional line with an open end are in particular configured such that a total reflection of the high-frequency signal takes place by the ground line and/or the additional line.

According to a further embodiment, the lines comprise microstrip lines, coplanar lines, stripline lines, waveguides and/or coaxial lines. In particular in coupler circuits with microstrip lines, the microstrip lines are usually configured such that they use the greatest possible substrate height since the lowest possible losses are hereby realized by the line. However, if a distance to a ground plane (reference ground) of the microstrip line is increased, the conductor track width of the microstrip line must, however, be increased to keep the impedance the same. Consequently, in such a case, more area is taken up on the substrate by the microstrip line. In particular with coupler circuits that use microstrip lines, there is thus a requirement to save space on a circuit board. Consequently, the advantages of the invention are in particular evident when using microstrip lines.

According to a further embodiment, the first and/or second switching apparatus each comprises/comprise an SPDT semiconductor switch (SPDT for “Single Pole Double Throw”, i.e. a changeover switch), a mechanical switching relay or a PIN diode. In particular, the transmission power of the antenna arrangement depends on and/or is limited by the kind of switching apparatus.

According to a further embodiment, the coupler inputs are connected to a DPDT switch (DPDT for “Double Pole Double Throw”, i.e. a double changeover switch) that is configured to couple the signal input to the first coupler input or the second coupler input and to short-circuit the respective other coupler input to ground. If the signal input is connected to the first coupler input, the input signal is forwarded to the first coupler output in the decoupling mode and the second coupler output is isolated. If, however, the signal input is connected to the second coupler input, the input signal is forwarded to the second coupler output in the decoupling mode and the first coupler output is isolated.

According to a further embodiment, the antenna arrangement further comprises a control apparatus that is configured to selectively control the DPDT switch, the first switching apparatus and/or the second switching apparatus. The control apparatus is thus able to set the coupler circuit to the different operating modes, i.e. coupling mode, decoupling mode or partial coupling mode. In particular, the control apparatus can automatically adjust the operating mode of the coupler circuit depending on a reception result of the antenna, i.e. change from a linear polarization to a circular or elliptical polarization and vice versa. Furthermore, the control apparatus can control the respective switching apparatus depending on the amplitude of the input signal. With a high amplitude of the input signal, it can, for example, be advantageous to operate the coupler circuit in a coupling mode since the division of the input signal and the associated loss of transmission power is acceptable to achieve a larger number of potential receivers of the transmission signal of the antenna in return. Conversely, at a small amplitude of the input signal, it can be expedient to operate the coupler circuit in the decoupling mode to achieve a higher transmission power of the transmission signal of the antenna.

A further aspect of the invention relates to a coupler circuit that comprises:
a first coupler input connected to a first node;
a second coupler input connected to a second node;
a first coupler output connected to a third node; and
a second coupler output connected to a fourth node,
wherein the first and third node are electrically coupled to one another via a first line,
wherein the second and fourth node are electrically coupled to one another via a third line,
wherein the first and second node can be electrically coupled via a second line by means of a first switching apparatus,
wherein the third and fourth node can be electrically coupled via a fourth line by means of a second switching apparatus.

A further aspect of the invention relates to a method for receiving and transmitting electromagnetic waves of different polarization that comprises:
a high-frequency input signal being applied to a coupler circuit according to any one of the preceding claims,
a polarized electromagnetic wave being transmitted by an antenna connected to the coupler circuit,
wherein the kind of polarization of the electromagnetic wave is changed by switching the first and/or second switching apparatus of the coupler circuit.

A further aspect of the invention relates to an RFID reader (RFID for Radio Frequency Identification) comprising an antenna arrangement of the kind described herein. The RFID reader comprises an evaluation unit that transmits readout signals in the form of input signals to the signal input of the antenna arrangement in order to transmit radio signals to RFID tags, wherein the evaluation unit is configured to evaluate signals transmitted by RFID tags and received via the antenna arrangement.

The statements on the antenna arrangement apply accordingly to the coupler circuit, the RFID reader and the method. This in particular applies with respect to embodiments and advantages.

Different embodiments of the invention will be described below with reference to the drawings. There are shown:

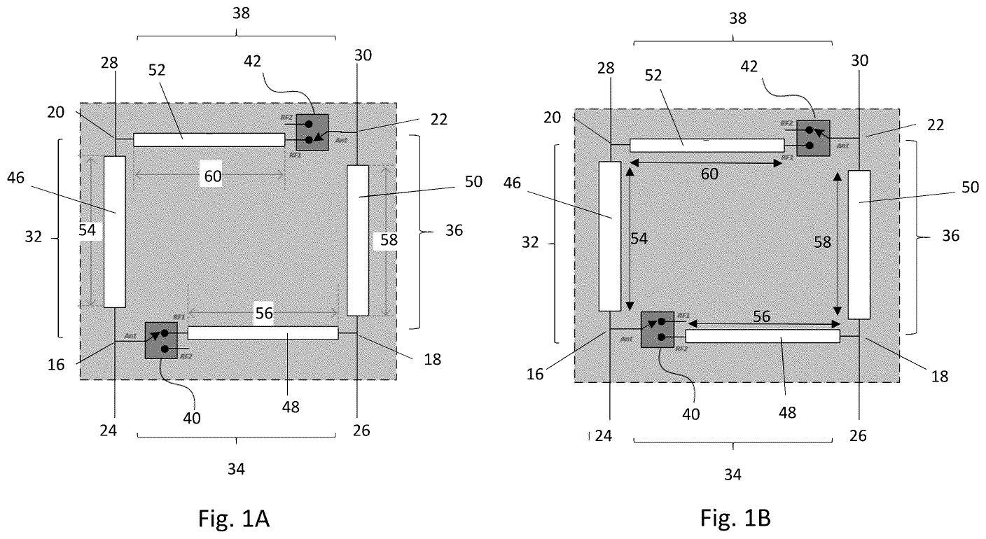

FIGS. 1A and 1B a coupler circuit in a coupling mode and a decoupling mode;

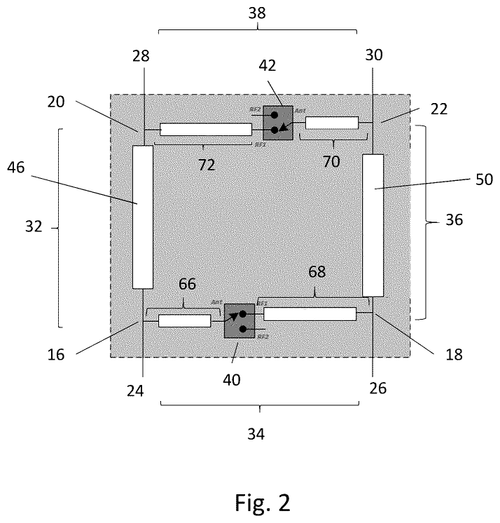

FIG. 2 a coupler circuit according to a further embodiment;

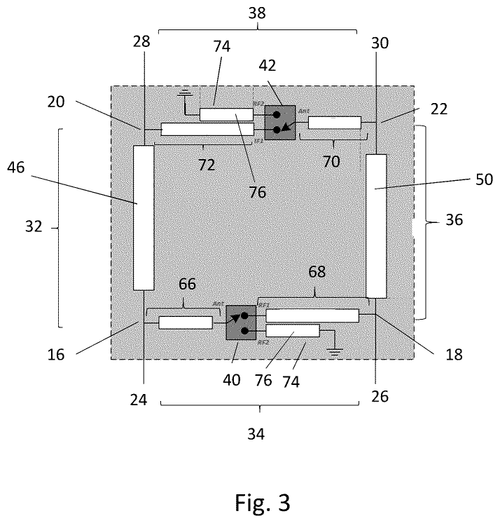

FIG. 3 a coupler circuit according to a further embodiment;

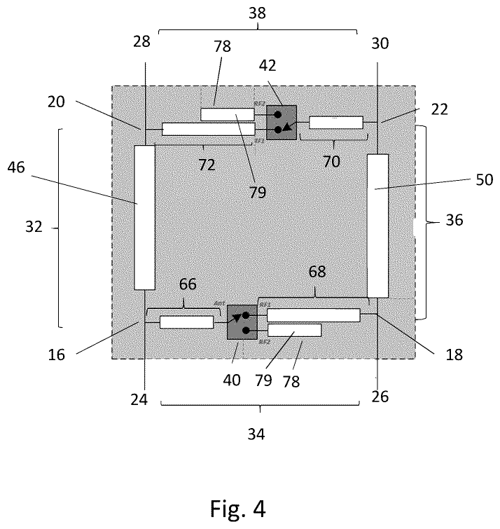

FIG. 4 a coupler circuit according to a further embodiment; and

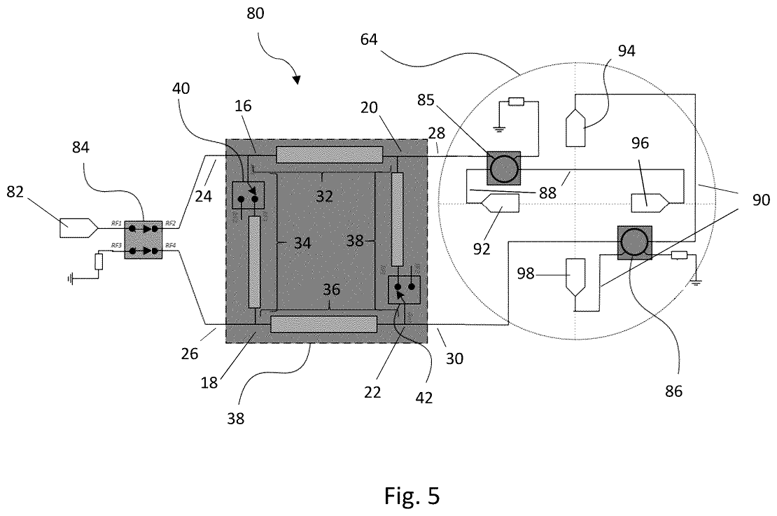

FIG. 5 an antenna arrangement comprising a coupler circuit.

FIGS. 1A and 1B show a coupler circuit 12 for use in an antenna arrangement 80, not shown, for receiving and transmitting electromagnetic waves of different polarization, wherein the coupler circuit 12 is operated in the coupling mode in FIGS. 1A and 1n the decoupling mode in FIG. 1B.

The coupler circuit 12 comprises a first coupler input 24 connected to a first node 16, a second coupler input 26 connected to a second node 18, a first coupler output 28 connected to a third node 20 and a second coupler output 30 connected to a fourth node 22. The first and third node 16, 20 are furthermore electrically coupled to one another via a first line 32, wherein the second and fourth node 18, 22 are electrically coupled to one another via a third line 36. Furthermore, the first and second node 18, 20 are electrically couplable to one another via a second line 34 by means of a first SPDT switch 40, wherein the third and fourth node 20, 22 are electrically couplable via a fourth line 38 by means of a second SPDT switch 42.

Each line has a respective impedance 46, 48, 50, 52, wherein the impedances 46, 50 of the first line 32 and the third line 36 are of equal magnitude and each assume an impedance value of Z₁. Furthermore, the impedances 48, 52 of the second line 34 and the fourth line 38 are of equal magnitude and each have an impedance value of Z₂. The relationship Z₁=0.707*Z₂ applies to the impedances Z₁ and Z₂. This dimensioning of the impedances ensures that the amplitudes of the two output signals of the coupler outputs 28, 30 are substantially of equal magnitude.

Each line 32, 34, 36, 38 further has an electrical length that indicates the phase offset of the transmitted signal caused by the line. In the present case, the electrical length 54, 58 of the first and third line 32, 36 in each case corresponds to an electrical length L1 that corresponds to a phase offset of 90°. Furthermore, the electrical length 56, 60 of the second and fourth line 34, 38 in each case corresponds to an electrical length L2, wherein the electrical length L2 and the electrical length L_{S} of the first and second SPDT switches 40, 42 are dimensioned such that the electrical length L_{2S}=L2+L_{S} corresponds to a phase offset of 90°.

As shown in 1A and 1B, the SPDT switch 40 is arranged at an end of the second line 34 that is closer to the first line 32 in close proximity to the first node 16 and the second of the SPDT switches 42 is arranged at an end of the fourth line 38 that is closer to the third line 36 in close proximity to the fourth node 22.

In the coupling mode, which is shown in FIG. 1A, the SPDT switches 40, 42 are in a coupling state, i.e. the SPDT switches 40, 42 are closed, and connect the first and second nodes 16, 18 via the second line 34 and the third and fourth nodes 20, 22 via the fourth line 38. When an input signal 44 is applied to the first or second coupler input 24, 26, the input signal 44 is thus divided so that a respective output signal is present at the first and second coupler outputs 28, 30 and has a reduced signal power compared to the input signal 44.

In the following, it is assumed that the input signal 44 is applied to the first coupler input 24, wherein, in the event that the input signal 44 is applied to the second coupler input 26, the mode of operation of the coupler circuit 12 applies accordingly.

The input signal 44 present at the first coupler input 24 is conducted, on the one hand, from the first node 16 via the first line 32 to the third node 20 and is thus conducted to the first coupler output 28, wherein the output signal of the first coupler input 24 is phase-shifted by 90° with respect to the input signal 44 and is reduced in its amplitude.

On the other hand, the input signal 44 present at the first coupler input 24 is conducted to the second coupler output 30 via two different paths 43, 45. The input signal 44 is conducted to the second coupler output 30 via a first path 43, namely from the first node 16 via the second line 34 to the second node 18 and from the second node 18 via the third line 36 to the fourth node 22, and via a second path 45, namely from the first node 16 via the first line 32 to the third node 20 and from the third node 20 via the fourth line 38 to the fourth node 22. The signal transmitted via the first path 43 and the signal transmitted via the second path 45 are phase-shifted by 180° at the fourth node 22 with respect to the input signal 44 and are phase-shifted by 90° with respect to the output signal of the first coupler output 28 and reduced in their amplitude. The signal transmitted via the first path 43 and the signal transmitted via the second path 45 are combined and added at the fourth node 22 so that the addition of the two signals is available as an output signal at the second coupler output 30. The output signal of the second coupler output 30 likewise has a phase offset of 180° with respect to the input signal 44 or of 90° with respect to the output signal of the first coupler output 28. Furthermore, the amplitude of the output signal of the second coupler output 30 corresponds to the amplitude of the output signal of the first coupler output 28.

The output signals of the first and second coupler outputs 28, 30 can subsequently be used in the coupling mode to be fed via feed points 92, 94, 96, 98 of a patch antenna 64, not shown, into the patch antenna 64 to generate and transmit a circularly or elliptically polarized RF wave.

In the decoupling mode, which is shown in FIG. 1B, the SPDT switches 40, 42 are in a decoupling state, i.e. the SPDT switches 40, 42 are open, so that an electrical connection between the first and second node 16, 18 via the second line 34 and between the third and fourth node 20, 22 via the fourth line 38 is interrupted. When an input signal 44 is applied to the first or second coupler input 24, 26, the input signal 44 is thus now not divided, but is conducted from the first node 16 via the first line 32 to the third node 20 and thus to the first coupler output 28, wherein the output signal of the first coupler input 28 is phase-shifted by 90° with respect to the input signal 44 and is reduced in its amplitude. The second coupler output 30 is thus isolated, i.e. no output signal is output via the second coupler output 30.

The output signal of the first coupler output 28 can be used in the decoupling mode to be fed into the patch antenna 64 via feed points 92, 94, 96, 98 of the patch antenna 64, not shown, in order to generate and transmit a linearly polarized RF wave.

FIGS. 2 to 4 show further embodiments of the coupler circuit 12, wherein the coupler circuit 12 is only shown in the coupling mode for the sake of simplicity.

FIG. 2 shows a coupler circuit 12 that differs from the coupler circuit 12 of FIG. 1A in that the SPDT switches 40, 42 in FIG. 2 are arranged more centrally along the second line 34 or the fourth line 38 than in FIG. 1A. The first SPDT switch 40 is in this respect arranged between a first subline 66 of the second line 34 and a second subline 68 of the second line 34 and the second SPDT switch 42 is arranged between a first subline 70 of the fourth line 38 and a second subline 72 of the fourth line 38.

FIG. 3 shows a coupler circuit 12 that differs from the coupler circuit 12 of FIG. 2 in that, in the decoupling state, the first and second SPDT switches 40, 42 connect the first subline 66, 70 of the second or fourth line 34, 38 to a ground line 74 that is connected to ground, wherein an impedance 76 of the ground line 74 has an impedance value Z_{M}.

FIG. 4 shows a coupler circuit 12 that differs from the coupler circuit 12 of FIG. 2 in that, in the decoupling state, the first and second SPDT switches 40, 42 connect the first subline 66, 70 of the second or fourth line 34, 38 to an additional line with an open end 78.

The additional line element of FIGS. 3 and 4, i.e. the ground line 74 and the additional line with an open end 78, can optimize the transmission attenuation, i.e. the isolation of the second coupler output 30, in the decoupling mode since mismatches of the coupler circuit can hereby be compensated.

FIG. 5 shows an antenna arrangement 80, in particular an RFID antenna arrangement, comprising a coupler circuit 12 for receiving and transmitting RF waves of different polarization. The antenna arrangement 80 comprises a signal input 82 having a high frequency input signal 44, wherein the signal input 82 is connected to a DPDT switch 84 that couples the signal input 82 to a first coupler input 24 of the coupler circuit 12 and connects a second coupler input 26 of the coupler circuit 12 to ground. Alternatively, the DPDT switch 84 can switch the signal input 82 to the second coupler input 26 and can connect the first coupler input 24 to ground, wherein, for example, the polarization angle and/or the polarization direction of the RF wave can hereby be changed, i.e. in dependence on the switch position of the DPDT switch 84.

The coupler circuit 12 shown in FIG. 5 corresponds to the coupler circuit 12 of FIG. 1A or 1B. As already described above, the coupler circuit 12 can be operated in the coupling mode or decoupling mode. In FIG. 5, the coupler circuit 12 is operated in the coupling mode so that an output signal is output at the first coupler output 28 to a first antenna coupler 85 that divides the output signal of the first coupler output 28 and feeds the divided signals via respective supply lines 80 to a first feed point 92 and a third feed point 96 disposed opposite the first feed point 92. Furthermore, an output signal is output at the second coupler output 30 to a second antenna coupler 86 that divides the output signal of the second coupler output 30 and feeds the divided signals via respective supply lines 90 to a second feed point 94 and a fourth feed point 98 disposed opposite the second feed point 94. The phase offset between the output signal of the first coupler output 28 and the output signal of the second coupler output 30 in this respect corresponds to 90°, while the amplitudes of the two signals are substantially the same. The supply lines 88 of the first and third feed points 92, 96 are in particular arranged offset by 90° from the supply lines 90 of the second and fourth feed points 94, 98, whereby the resulting RF wave is circularly or elliptically polarized.

When the coupler circuit 12 is operated in the decoupling mode, the input signal 44 is not divided, but is conducted from the first node 16 via the first line 32 to the third node 20 and to the first coupler output 28. The second coupler output 30 is then isolated, i.e. no output signal is output via the second coupler output 30. As already in the coupling mode, the output signal of the first coupler output 28 is output to the first antenna coupler 85 that divides the output signal of the first coupler output 28 and feeds the divided signals via the respective supply lines 88 to the first feed point 92 and the third feed point 96. No signals are fed in via the second and fourth feed points 94, 98 so that the resulting RF wave is linearly polarized.

### REFERENCE NUMERAL LIST

12 coupler circuit
14 antenna arrangement
16 first node
18 second node
20 third node
22 fourth node
24 first coupler input
26 second coupler input
28 first coupler output
30 second coupler output
32 first line
34 second line
36 third line
38 fourth line
40 first SPDT switch
42 second SPDT switch
43 first path
44 input signal
45 second path
46 impedance of the first line
48 impedance of the second line
50 impedance of the third line
52 impedance of the fourth line
54 electrical length of the first line
56 electrical length of the second line
58 electrical length of the third line
60 electrical length of the fourth line
64 patch antenna
66 first subline of the second line
68 second subline of the second line
70 first subline of the fourth line
72 second subline of the fourth line
74 ground line
76 impedance of the ground line
78 additional line with an open end
79 impedance of the additional line with an open end
80 antenna arrangement
82 signal input
16 DPDT switch
85 first antenna coupler
86 second antenna coupler
88,90 supply lines
92 first feed point
94 second feed point
96 third feed point
98 fourth feed point

1. An antenna arrangement for receiving and transmitting electromagnetic waves of different polarization, said antenna arrangement comprising:
an antenna that has at least two feed points arranged spaced apart from one another, wherein the antenna is configured to transmit a polarized electromagnetic wave;
a signal input for a high-frequency input signal;
a coupler circuit that is coupled to the signal input and that comprises:
a first coupler input connected to a first node;
a second coupler input connected to a second node;
a first coupler output connected to a third node; and
a second coupler output connected to a fourth node,
wherein the first and third node are electrically coupled to one another via a first line,
wherein the second and fourth node are electrically coupled to one another via a third line,
wherein the first and second node can be electrically coupled via a second line by means of a first switching apparatus,
wherein the third and fourth node can be electrically coupled via a fourth line by means of a second switching apparatus,
wherein the signal input can be coupled to the first coupler input or to the second coupler input, wherein the first and second coupler output are each connected to one or more feed points of the antenna.

2. The antenna arrangement according to claim 1,
wherein the antenna arrangement is an RFID antenna arrangement.

3. The antenna arrangement according to claim 1,
wherein the coupler circuit can be operated in a decoupling mode and in a coupling mode,
wherein the coupler circuit is configured in the decoupling mode such that the first and second switching apparatus are operated in a decoupling state so that the signal input is only connected to the first or second coupler output, wherein the antenna is configured in the decoupling mode to transmit a linearly polarized electromagnetic wave,
wherein the coupler circuit is configured in a coupling mode such that the first and/or second switching apparatus is/are operated in a coupling state so that the signal input is connected to the first and second coupler output,
wherein the antenna is configured in the coupling mode to transmit a circularly polarized or elliptically polarized electromagnetic wave.

4. The antenna arrangement according to claim 1,
wherein an electrical length of the first line substantially corresponds to an electrical length of the third line, wherein the electrical length of the first and/or third line corresponds to an electrical length L1 in each case,
wherein an electrical length of the second line substantially corresponds to an electrical length of the fourth line, wherein the electrical length of the second and/or fourth line corresponds to an electrical length L2 in each case,
wherein an electrical length of the first switching apparatus substantially corresponds to an electrical length of the second switching apparatus,
wherein the electrical length of the first and second switching apparatus corresponds to an electrical length L_{S} in each case,
wherein a phase offset L_{2S} caused jointly by the electrical lengths L2 and L_{S} substantially corresponds to an odd integer multiple of 90°.

5. The antenna arrangement according to claim 1,
wherein the first and third line each have a first impedance, wherein the second and fourth line each have a second impedance, wherein the first impedance and the second impedance are selected such that output signals with substantially the same amplitude are output at the first coupler output and the second coupler output.

6. The antenna arrangement according to claim 3,
wherein the coupler circuit can be operated in a partial coupling mode in which the first switching apparatus is operated in the coupling state and the second switching apparatus is operated in the decoupling state or vice versa,
wherein the antenna is configured to transmit an elliptically polarized electromagnetic wave in the partial coupling mode.

7. The antenna arrangement according to claim 1,
wherein the first switching apparatus is arranged at an end of the second line that is closer to the first line and the second switching apparatus is arranged at an end of the fourth line that is closer to the third line or the first switching apparatus is arranged at an end of the second line that is closer to the third line and the second switching apparatus is arranged at an end of the fourth line that is closer to the first line.

8. The antenna arrangement according to claim 1,
wherein the first switching apparatus is arranged between a first subline of the second line and a second subline of the second line.

9. The antenna arrangement according to claim 1,
wherein the second switching apparatus is arranged between a first subline of the fourth line and a second subline of the fourth line.

10. The antenna arrangement according to claim 8,
wherein the first and/or second switching apparatus is/are configured in the decoupling state to connect the respective first or second subline to a ground line.

11. The antenna arrangement according to claim 9,
wherein the first and/or second switching apparatus is/are configured in the decoupling state to connect the respective first or second subline to a ground line.

12. The antenna arrangement according to claim 8,
wherein the first and/or second switching apparatus is/are configured in the decoupling state to connect the respective first or second subline to an additional line with an open end.

13. The antenna arrangement according to claim 9,
wherein the first and/or second switching apparatus is/are configured in the decoupling state to connect the respective first or second subline to an additional line with an open end.

14. The antenna arrangement according to claim 1,
wherein the lines comprise microstrip lines, coplanar lines, stripline lines, waveguides and/or coaxial lines.

15. The antenna arrangement according to claim 1,
wherein the first and/or second switching apparatus each comprises/comprise an SPDT semiconductor switch, a mechanical switching relay or a PIN diode.

16. The antenna arrangement according to claim 1,
wherein the coupler inputs are connected to a DPDT switch that is configured to couple the signal input to the first coupler input or the second coupler input and to short-circuit the respective other coupler input to ground.

17. The antenna arrangement according to claim 16,
further comprising a control apparatus that is configured to selectively control the DPDT switch, the first switching apparatus and/or the second switching apparatus.

18. A coupler circuit comprising:
a first coupler input connected to a first node;
a second coupler input connected to a second node;
a first coupler output connected to a third node; and
a second coupler output connected to a fourth node,
wherein the first and third node are electrically coupled to one another via a first line,
wherein the second and fourth node are electrically coupled to one another via a third line,
wherein the first and second node can be electrically coupled via a second line by means of a first switching apparatus,
wherein the third and fourth node can be electrically coupled via a fourth line by means of a second switching apparatus.

19. A method for transmitting electromagnetic waves of different polarization that comprises:
a high-frequency input signal being applied to a coupler circuit according to claim 18,
a polarized electromagnetic wave being transmitted by an antenna connected to the coupler circuit,
wherein the type of polarization of the electromagnetic wave is changed by switching the first and/or second switching apparatus of the coupler circuit.
